(19) United States
(12) Patent Application Publication
(10) Pub. No.: US 2010/0116592 A1
(43) Pub. Date: May 13, 2010

(54) Adjustable Stepladder

(76) Inventors: Jeffrey David Clements, Hartford, WI (US); Rodney Wayne Rosenthal, Colgate, WI (US)

Correspondence Address: JEFFREY DAVID CLEMENTS, 1083 MAYO RD., HARTOFORD, WI, 53027, US

(21) Appl. No.: 12/269,016

(22) Filed: Nov. 11, 2008

(51) Int. Cl. E06C 7/04

(52) U.S. Cl. 182/180.1

(57) ABSTRACT

A stepladder with four individually adjustable, self-locking rails so that the ladder can be placed on uneven terrain then safely adjusted to maintain level orientation. The ladder rails will consist of four pairs of outer and inner rails. Each outer and inner rail pair is designed with profiles that when brought together will lock into one another providing stability yet minimal friction. Each inner rail is held in place by a spring-loaded lever with attached hooks. The spring forces the hooks to be engaged with an adjustment bracket that is fixed to the outer rail. A foot will be fixed to the bottom of each inner rail. Each foot will have arched surfaces along 2 perpendicular horizontal axes so that consistent surface area contact is maintained with the ground regardless of the angle of the ground. On a level surface, when the ladder is in an un-adjusted state, the four inner rails are designed to be extended with respect to the outer rails providing equal distance between each step and reducing weight and production costs.

### BACKGROUND OF THE INVENTION

1. Field of the Invention

The present invention relates generally to ladder type devices used to access elevated locations and more specifically to a stepladder with extendable and retractable support rails used to quickly and safely position the ladder with a level orientation in multiple dimensions regardless of the underlying surface or terrain. The improved ladder device incorporates movable and positive locking inner rails allowing one person to quickly and easily position the ladder on steep slopes in finite degree of adjustment with no assistance and without risking loss of control, avoiding the dangers associated with prior art and other methods of leveling the ladder. Easy to manufacture and with no loose parts, this improvement eliminates the potential loss and use of non-conforming, potentially unsafe replacement parts. The ladder rail position markers allow the user to understand the differences between the lengths of the ladder rails communicating the extent of the ladder extension or retraction. Extension and retraction are stopped at the maximum and minimum travel distances by built in stoppers which prevent users from adjusting to unsafe positions. Support styles are not compromised by large adjusting holes subject to specific stress, and all pinch points are internal to the adjustment mechanism eliminating potential hazard and catch points of prior art.

2. Description of the Related Art

In search of prior art, no devices were found that would allow for both a swift one-handed adjustment by one person without the potential for loss of control of the ladder, and a safe, positive locking mechanism without the ability to unlock from shifting weight or moving terrain. Additionally, the related prior art only describes the adjustment method from a perspective of extension, and does not take into account the function of retraction from the un-adjusted point of setup. Many prior art devices have catch points on the adjustment mechanism which could get caught on other objects when transporting or in use, and could accidentally fail as a result of catching on other objects and people. The lack of a method to determine the length of adjustment or retraction and the lack of safety stops in retract and extend directions on the related art creates difficulty and a potentially unsafe condition for the user. Prior art in many cases does not take into consideration a fastening method between the rails and steps such that it does not interfere with rail adjustments. The following art was determined to have similar specific properties and therefore considered related.

1. Independently Adjustable Ladders
The Parks Patent (U.S. Pat. No. 6,779,632) discloses an adjustable ladder rail of telescopic nature held in place by a threaded bolt and nut through a plurality of holes. This device, however, is not easily adjustable in a safe manner by one person due to the simultaneous requirements of the operator to hold the ladder steady, unscrew the nut from the bolt, pull the bolt, extend the rail, reinsert the bolt, and rethread the nut on the bolt. Further, the use of small detached parts subject to loss and improper replacement may lead to unsafe application. For safety, it is imperative the ladder maintain full contact with the uneven terrain in any or multiple slope direction. The ladder feet on the Parks device only allow for sloping terrain in one dimension, also subjecting the feet bolts to strain and potential breakage or unsafe conditions. Similarly Eaton, (U.S. Pat. No. 6,702,066) who discloses wing nuts and Joseph, (U.S. Pat. No. 5,577,574) who discloses tubes with locking pins and Hutson and Hutson, (U.S. Pat. No. 5,853,065) who discloses square tubes with a pin are subject to the same issues. Nurkiewicz, (U.S. Pat. No. 6,374,947) discloses small foot blocks to address sloped terrain but does not address the other issues noted above.
The Jackson Patent (U.S. Pat. No. 7,121,382) discloses an adjustable ladder rail of telescopic nature held in place by a pin with spring-loaded latch through a plurality of holes. This device, however, is not easily adjustable in a safe manner by one person due to the simultaneous requirements of the operator to hold the ladder steady, pinch the latch, pull the pin extend the rail and reinsert the pin. Manufacture of this device would be complicated to insure the steps of the ladder were sound but allowed the necessary travel for the rails. Jackson, (U.S. Pat. No. 7,222,696) and Baily, (U.S. Pat. No. 6,729,440) disclose similar spring loaded pins and clips subject to the same issues relating to loose and worn parts, two hands to line up holes, feet that only adjust to terrain in two dimensions and the need for two hands to extend a rail.
Crawford, (U.S. Pat. No. 6,799,660) discloses an adjustment method based on threaded inner tubes. Adjustment time would be very slow thereby increasing the time a person would need to set up on sloped terrain and decreasing safety. Adjustment requires multiple hands, and manufacture of this device would be complicated to insure the steps of the ladder were sound but allowed the necessary travel for the rails. Also the requirement of a loose tool and concerns about terrain contact create safety concerns. Similarly Christy, (U.S. Pat. No. 5,816,364) discloses long screws and is subject to the same issues.
Schwartzel, (U.S. Pat. No. 6,237,718) discloses an adjustment device using straps, ratchets, and pulleys. Issues facing this device include slow adjustment time, not adjustable with one hand, not easy to manufacture, external parts subject to wear and the elements, the need for and extra hand to extend rail, feet in only two dimensions and pinch points for the user.
McCrystal, (U.S. Pat. No. 6,073,726) discloses an adjustment mechanism utilizing a spring loaded clip to insert pins into holes in tubes traversing one inside the other. The clip and the pins can easily be compressed with one hand, but no account is taken for the adjustment of the rail. It also shows locking clips separate from the ladder, subjecting the device to the same issues as the prior art relating to potentially lost parts. The device has movable steps which while allowing for a very large range of adjustment would require additional set time and potentially subject the user to unsafe conditions during setup. The device is subject to the limitations of manufacture, open pinch points, catch points and one dimensional feet. Additionally, the long nature of the rails makes manufacture of this device expensive and use of the device difficult due to the weight of the long rails.
The Studer patent, (U.S. Pat. No. 5,074,378) discloses locking cams. These cams could come loose if weight was lifted off the ladder. The device is subject to the limitations of manufacture, it requires two hands to extend rail, displays feet in only two-dimensions, and is difficult to attach steps while allowing rail adjustment.
Katson, (U.S. Pat. No. 5,305,851) discloses an adjustment method where two u-shaped styles attach one inside the other and are adjustable and secured by a double pin style locking mechanism. This device is subject to the same limitations of similar tube shaped devices.

2. Non-Independent Adjustments
Many previous attempts like Walden, (U.S. Pat. No. 6,604,607) disclose extension style hooks to make large adjustments to the climb up side of a ladder. These attempts do not allow independent rail adjustment on multiple slope terrain. Additionally, they allow for only large adjustments potentially subjecting the user to safety issues due to lack of ability to reach a level, stable setup.

3. Add on Adjustable Rails
Sheffield, (U.S. Pat. No. 6,450,292), Martin, (U.S. Pat. No. 5,913,382) and a plurality of others disclose—bolt on extensions with minimal adjustment travel. These types of devices are subject to increased stress at specific points of attachment, potential safety issues due to side load on multiple slope terrain, and interference points based on method of attachment. Additionally, like Thocher et al, (U.S. Pat. No. 5,273,133) most of these devices are designed for attachment to a rung style extension ladder, not a stepladder.
Lu, (U.S. Pat. No. 5,148,892) discloses a general quick stand adjusting device which could be attached to a stepladder. This device would be subject to the limitation of any bolt on adjustment device, would allow for very limited adjustment travel, and would be difficult to manufacture and market to the ladder industry.

While specific features of some of the aforementioned references are incorporated in the improved device, alone and in combination with the other devices the improved device is significantly different and distinguishable from prior art.

### SUMMARY OF THE INVENTION

It is the overall object of the improved adjustable stepladder to provide a safe manner to increase the height of a person or object. It is the object of the improved adjustable stepladder to act as a standard stepladder, and to provide integrated independently extendable and retractable rails to allow fast and safe positioning on unevenly sloped terrain or surfaces like hills, stairs roofs or others surfaces. The improved stepladder provides safe-and easy adjustment by a single individual while maintaining safe hold and control over the stepladder. The improved stepladder provides a positive locking mechanism for safe operation without compromising the strength of the stepladder while minimizing weight. The improved stepladder provides improved feet designed to maximize surface contact regardless of slope orientation without undue stress and wear points. The improved stepladder can be manufactured to any height. The improved stepladder can be manufactured with steps on one side or both sides, can be made out of wood, metal, fiberglass, plastic or multiple other materials, and can incorporate many other integrated or add-on tools or functional devices. The improved stepladder rails can be parallel or otherwise slanted to offer maximum stability and safety for the user. In combination, the retraction and extension of the improved stepladder provides great enough travel to handle typical slopes and finite enough adjustment settings to provide level setup and safe use. The improved adjustable stepladder can be easily manufactured, assembled, stored and transported. The improved stepladder provides for safe adjustment in a manner minimizing hazardous catch points and pinch points. It is the object of the improved stepladder to be usable by the average person. It is the object of the improved stepladder to provide the user with and indication of the position of extension or retraction of the ladder rail.

### BRIEF DESCRIPTION OF THE DRAWINGS

FIG. 1 is a perspective view of the adjustable stepladder on an even surface in an un-adjusted state.

FIG. 1A is a close-up of the rail adjustment section for one inner and outer rail pair on the climb up side of the adjustable stepladder.

FIG. 2 shows the components of the rail adjustment section from FIG. 1A without the inner and outer rail.

FIG. 3 shows the movable; individual components of the rail adjustment section from FIG. 2 when spread apart from one another.

FIG. 4 illustrates how the foot is attached to the lower portion of the inner rail on the climb up section of the adjustable stepladder.

FIG. 5 illustrates how the foot is attached to the lower portion of the inner rail on the smaller, non-climb up section of the adjustable stepladder.

FIG. 6 illustrates how the step brackets are attached to the steps.

FIG. 7 illustrates how the non-climb up side brace supports are attached to the braces.

FIG. 8 Shows the components that make up the spreader braces.

FIG. 9 is a cross section of the inner and outer rails of the climb up side of the adjustable stepladder when locked together.

FIG. 10 is a cross section of the inner and outer rails of the non-climb up side of the ladder when locked together.

FIG. 11 is a cross section of an adjustable stepladder step.

FIG. 12 is a cross section of a non-climb up side brace.

### DESCRIPTION OF THE PREFERRED EMBODIMENTS

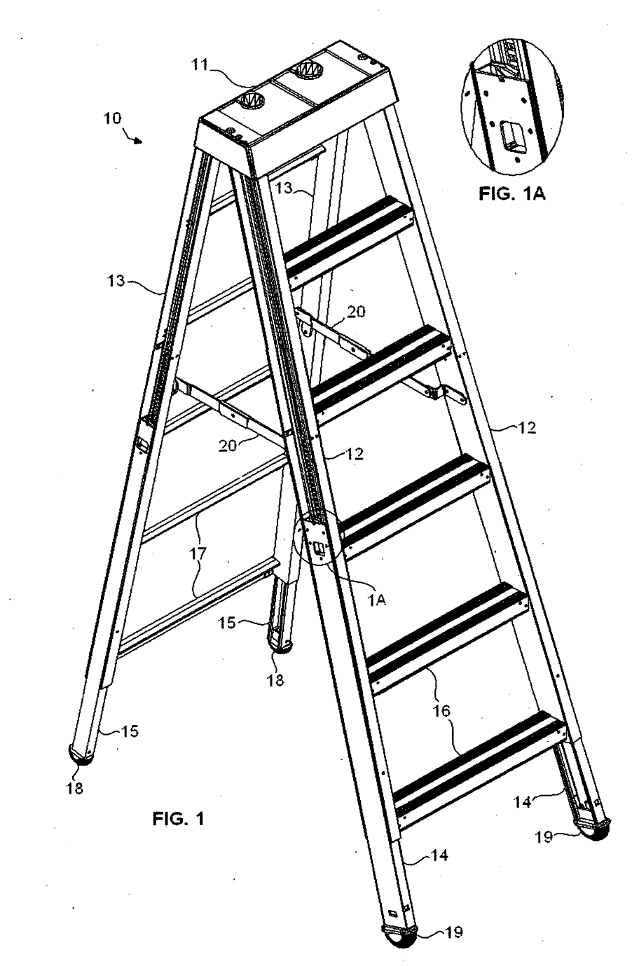

A detailed description of the adjustable stepladder will start with FIG. 1 showing the fully assembled ladder indicated by reference character 10. Ladder 10 will include a top tray 11 designed as a placement for miscellaneous tools and/or parts as well as a surface for mounting outer climb up side (CS) rail 12 and outer non-climb up side (NCS) rail 13. The outer CS rails 13 being fixed to the top tray 11 will support fixed steps 16 and the inner adjustable CS rails 14. The outer NCS rails 13 being fixed to the top tray 11 but allowed to swivel will support the NCS braces 17 and the inner adjustable NCS rails 15. Swivel distance of the inner adjustable NCS rails 13 will be contained by the spreader braces 20.

The inner adjustable CS rails 14 and inner adjustable NCS rails 15 will support the weight of the ladder and operator and will provide a mounting surface for the adjustment components near the top as indicated by FIG. 1A. The inner adjustable CS rails 14 and inner adjustable NCS rails 15 cannot be separated from the outer CS rails 12 and outer NCS rails 13 due complementing profiles and internal stops that limit both the retracting and extending distances. On a level surface, the inner adjustable CS rails 14 and inner adjustable NCS rails 15 will be partially extended to a position that is physically and/or visually referenced such that a uniform step distance is achieved.

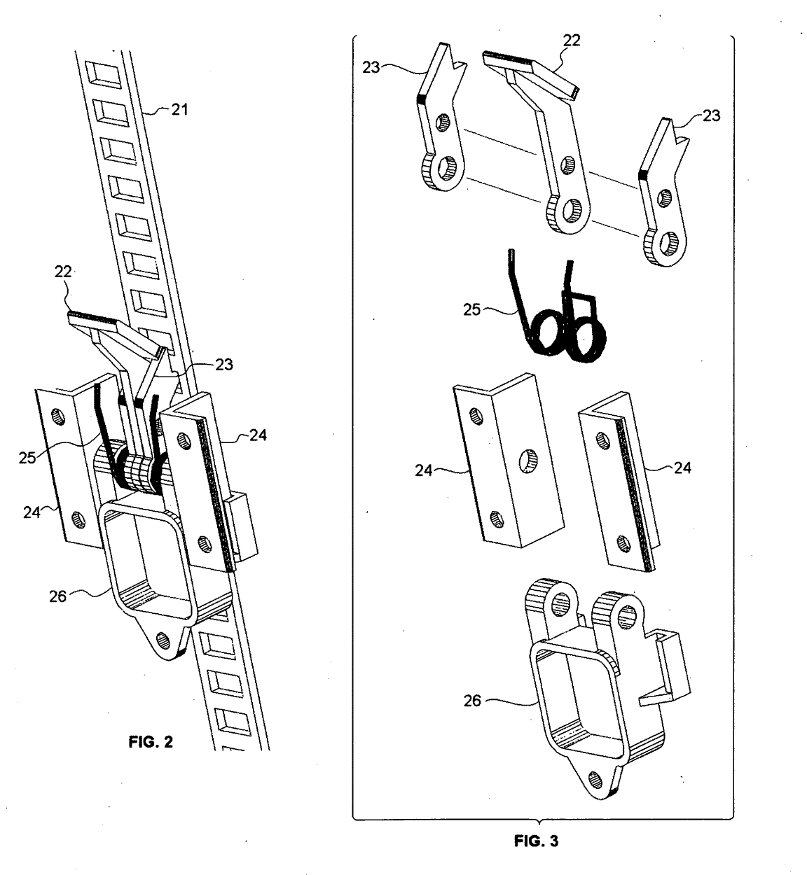

FIG. 2 shows the adjustments components from FIG. 1A without the inner adjustable CS rail 14 and outer CS rail 12. The adjustment bracket 21, containing a plurality of slots, is mounted to the outer CS rails 12 and outer NCS rails 13. The remainder of the components in FIG. 2 also, shown as separated in FIG. 3, will be mounted to inner adjustable CS rails 14 and inner adjustable NCS rails 15. When mounting the components shown in FIG. 3 to the inner adjustable NCS rails 15, the adjustment lever brackets 24 will be absent because the edges of the inner adjustable NCS rail 15, being of lesser width than the inner adjustable CS rail 14 can serve as a replacement. A hook 23 will be fastened to each side of the adjustment lever 22. To adjust in an upward direction, the inner adjustable CS rail 14 or the inner adjustable NCS rail 15, the ladder operator can pull back on the adjustment lever 22 with the thumb finger and as a result will cause the pair of hooks 23 to disengage from the adjustment bracket 21. While performing the aforementioned task, the operator can simultaneously place the forefinger in the finger hole 26 and pull in the direction of the adjustment. While this adjustment is taking place, the operator's other hand is free to grasp the ladder 10 to steady it. To adjust in an a downward direction, the inner adjustable CS rail 14 or the inner adjustable NCS rail 15, the ladder operator is not required to pull back on the adjustment lever 22. Simply applying a downward force with a thumb finger that's inserted into the finger hole 26 is enough to disengage the hooks 23 with the adjustment bracket 21.

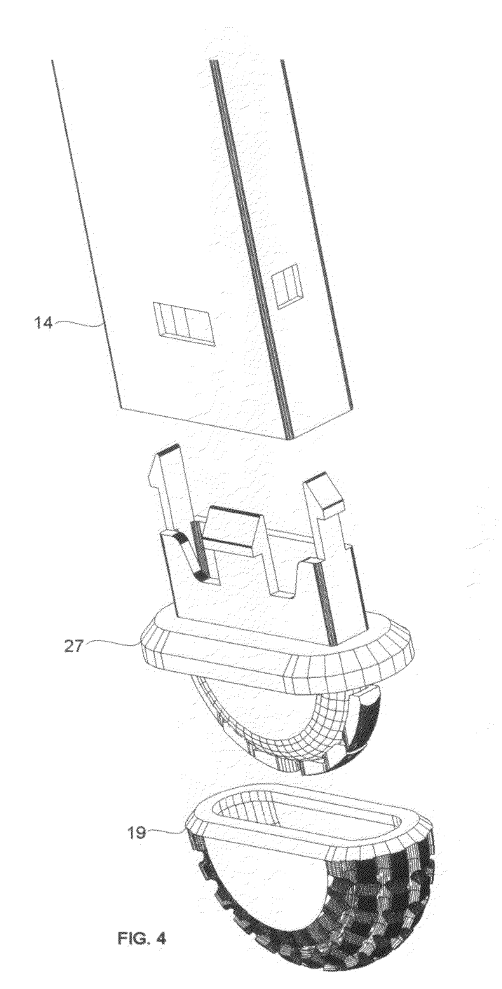

FIG. 4 illustrates how the pliable CS outer foot 19 attaches to the inner adjustable CS rail 14. A rigid CS inner foot 27 locks into three notches at the bottom of the inner adjustable CS rail 14. The CS outer foot 19 locks in to the CS inner foot 27 because of their complementing profiles.

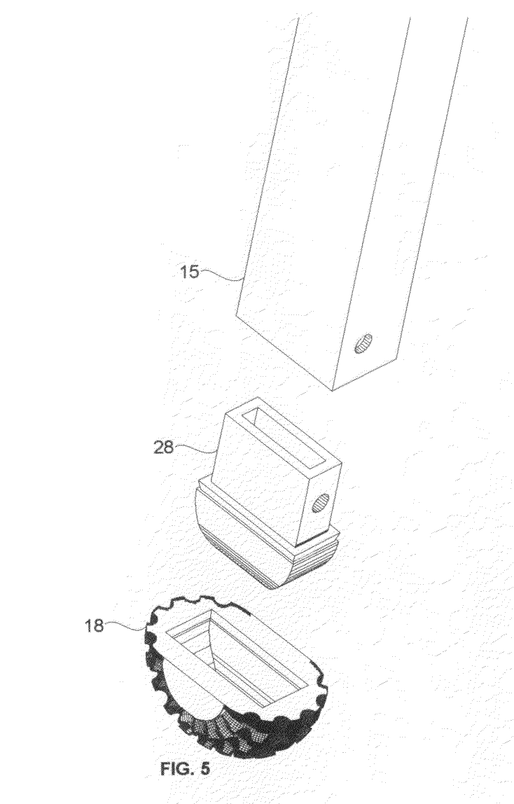

FIG. 5 illustrates how the pliable NCS outer foot 18 attaches to the inner adjustable NCS rail 15. A rigid NCS inner foot 28 is bolted to the bottom of the inner adjustable NCS rail 15. The NCS outer foot 18 locks in to the NCS inner foot 28 because of their complementing profiles.

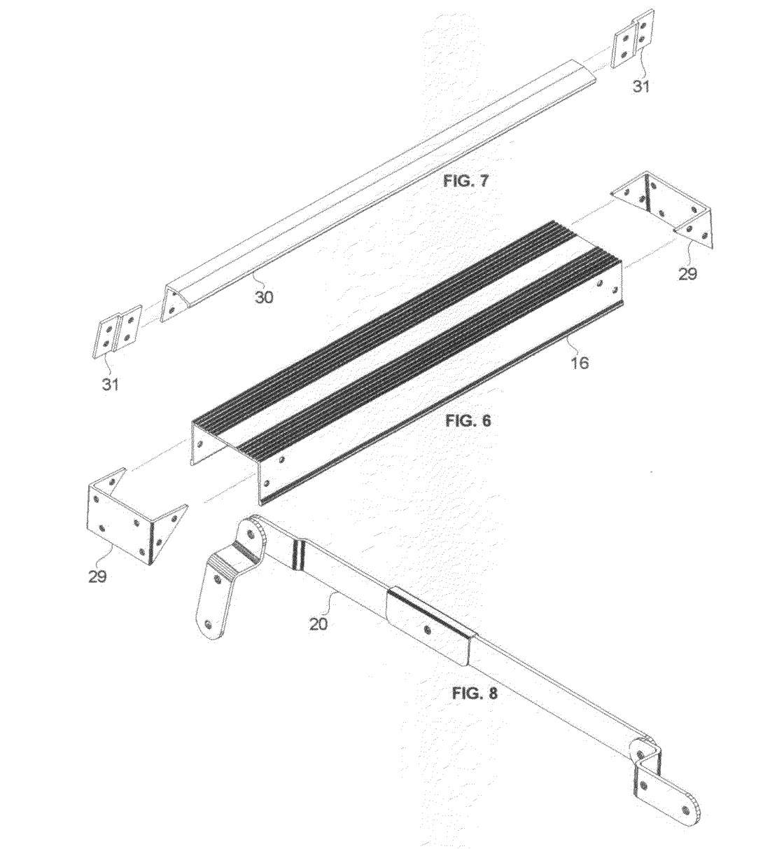

FIG. 6 illustrates how each ladder step 16 is attached to the outer CS rails 14 using a step bracket 29 on each side of the step 16 while FIG. 7 illustrates how each NCS brace 30 is attached to the outer NCS rails 15 using a NCS brace support 31 on each side of the NCS brace 30.

FIG. 8 illustrates how five individual pieces come together to create the spreader brace 20.

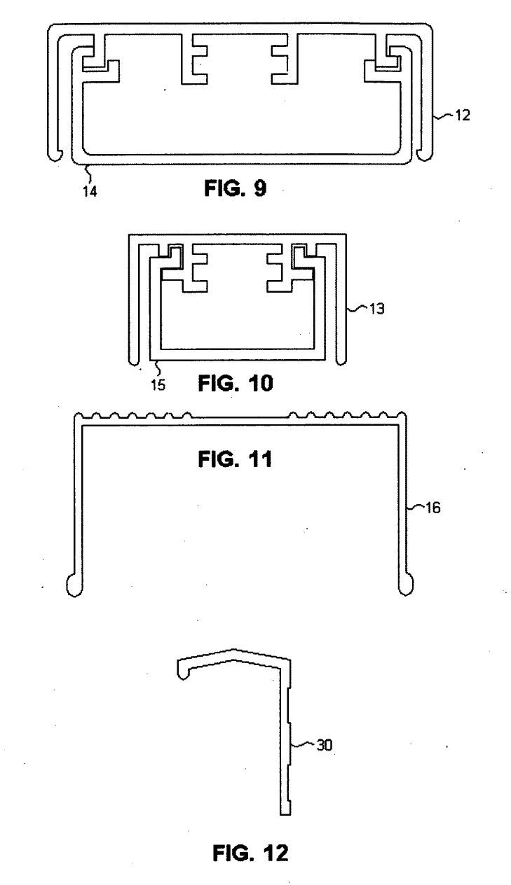

FIG. 9 and FIG. 10 illustrate how complementing profiles allow the inner and outer rail pairs to lock into one another. While the profiles for the outer CS rail 12 and outer NCS rail 13 appear quite different, the slots near the center are identical. These slots will house the adjustment bracket 21.

What is claimed is:

1. An adjustable stepladder comprising:
(a) A rectangular top tray comprising a top edge and four angled sides in which four outer support rails are vertically fastened to the corners with the outer rails in a usable state being spaced at a greater distance from one another at the bottom of the rails compared to the top of the rails in an effort to achieve maximum stability.
(b) A series of horizontal steps evenly spaced vertically from each other, the ground, and the top edge of the top tray and fastened to a pair of said outer rails by means of a step bracket on each end of the step.
(c) A series of horizontal support braces fastened to a second pair of said outer rails by means of a brace fastener on each end of the support brace.
(d) A pair of spreader braces, each fastened at the ends to said outer rail pairs and aiding in controlling the angle and distance between the outer rail pairs.
(e) Four Inner rails, each confined within one said outer rail with a portion of the cross section acting as the complement to a portion of the cross section of the outer rails to form a mate thereof, restricting movement of the inner rail along a parallel axis to the outer rail.
(f) Fixed feet resembling an elongated half sphere comprising a flexible outer shell attached to a rigid inner shell attached to the bottom of each said inner rail.
(g) A recessed, self-contained, self-locking inner rail height adjustment mechanism mounted to each said inner rail near the top edge enabling adjustment while in a prone state in as little as a fraction of a second with the use of one to three fingers, leaving one hand free to steady the ladder.
(h) A position indicator measuring inches and/or centimeters and fractions thereof to act as a reference point of said inner rail adjustment compared to its said outer rail mate.
(i) A pair of extension and retraction stoppers mounted to each said outer rail that limit the extension and retraction distance of each said inner rail and ensure that the bottom edge of the inner rail is never higher than the bottom edge of its outer rail mate.
(j) An aperture in the outer face of each said inner rail called a finger hole whereas an inner cap is aligned and fastened to form a pocket, enabling a user to have a surface in which a finger or several fingers can be placed to pull up or push down and thus adjust the height of the inner rail.

2. An adjustable stepladder set forth in claim 1, wherein to achieve a compactable storage configuration, and minimum weight configuration, all four outer rails are shorter than a conventional stepladder requiring that all four said inner rails be extended to a distance indicated by the position indicator, when the ladder is on a level surface, thus satisfying the requirement for equal distance between said horizontal steps, the top edge of the top tray, and the ground.

3. An adjustable stepladder set forth in claim 1, wherein the lowest said horizontal step and lowest said horizontal support brace are mounted near the bottom of the said outer rail pairs such that on steep surfaces, the requirement for equal distance between the said horizontal steps, the top edge of the top tray, and the ground can be satisfied and increased stability achieved.

4. An adjustable stepladder set forth in claim 1, wherein said outer shell of said fixed feet contain perpendicular half tubular omissions along the outer surface for extra traction.

5. An adjustable stepladder set forth in claim 1, wherein said adjustment mechanism is comprised of a lever recessed within each inner and outer rail pair, centered between and fastened to two hooks, each piece aligned at the base by a common aperture whereas a pin can be inserted providing a rotation point by which the hooks can engage and disengage with an adjustment bracket; said adjustment bracket, containing a series of adjustment apertures is fastened to and contained within the outer rail.

6. An adjustable stepladder set forth in claim 5, wherein said lever and hooks are centered between a double torsion spring which forces the hooks and lever toward said adjustment bracket.

7. An adjustable stepladder set forth in claim 5, wherein said finger hole is mounted just below said pin that contains said lever and hooks such that the surface of the lever and the upper surface of the finger hole enclosure are opposable providing a simple means to disengage the hooks with the adjustment bracket while simultaneously adjusting the height of the inner rail.
